(19) United States
(12) Patent Application Publication
(10) Pub. No.: US 2005/0217119 A1
(43) Pub. Date: Oct. 6, 2005

(54) Low-cost ring blade for rotary knives

(76) Inventor: Geoffrey D Rapp, Westlake, OH (US)

Correspondence Address: Watts Hoffmann Fisher & Heinke Co, 1100 Superior Avenue East, Suite 1750, Cleveland, OH, 44114-2518, US

(21) Appl. No.: 10/514,305

(22) PCT Filed: Aug. 22, 2003
(86) PCT No.: PCT/US03/26461

§ 371 Date: Nov. 12, 2004

Related U.S. Application Data
(60) Provisional application No. 60/408,769, filed on Sep. 6, 2002.

(51) Int. Cl. A22C 17/12

(52) U.S. Cl. 30/276; 452/133

(57) ABSTRACT

A ring blade (18) for use with a rotary knife (10) includes a first member that forms an annular blade member (90) having an annular cutting edge (96) for cutting into material with which it is brought into contact. A second member (92) is fixed to the annular blade member to provide a drive surface by which the ring blade is rotated. In one embodiment the blade member is machined. In another embodiment the blade member is cold formed from a thin sheet of hardenable steel.

### FIELD OF THE INVENTION

The present invention concerns low cost ring blade for use with a rotary knife.

### BACKGROUND ART

Knives utilizing rotatable ring blades are used in defatting and removing meat from bones in the meat processing industry. A typical hand-held rotary knife includes a circular ring blade that fits within a blade housing. The blade may be rotated by gearing driven from a flexible shaft attached to the hand held knife. One such rotary knife is depicted in published PCT patent application WO 01/24977 A2 which is incorporated herein by reference. Alternatively, the blade may be gear driven from an air or electric motor mounted in the knife handle and respectively supplied with source air through a flexible hose or electric power through a power cord.

Ring blades are costly to manufacture and maintain. The typical blade comprises a thin annular body section that is formed about a central axis, is frusto-conical and has an annular cutting edge at one axial end and an enlarged gear forming section at the opposite end. The blade is machined from a single piece of steel. The gear forming structure is hobbed to produce axially extending gear teeth that mesh with a driving pinion gear mounted in the knife. The blade cost is, in part, due to the relative complexity of the manufacturing processes required, the high degree of skilled labor required to produce the blade and the cost of the blade materials themselves.

### SUMMARY OF THE INVENTION

The present invention concerns a ring blade for use with a rotary knife. The ring blade comprises a first blade member formed by a continuous annulus extending about a central axis and having a cutting edge formed at one axial end for cutting into material with which the ring blade is brought into contact; and
a second member fixed to said first member for driving the first member rotatably about the central axis, said second member defining at least a drive surface by which rotatable drive is imparted to the ring blade.

In accordance with illustrated embodiments of the invention the driving member is molded onto the blade member during fabrication of the ring blade. The driving member may be made from structurally strong polymeric materials, powdered metals, ceramics, or other appropriate materials or combinations of materials. The illustrated embodiments of the invention utilize a polymeric material that is molded in place on the blade member and defines blade driving gear teeth that project from the ring blade generally oppositely from the blade edge.

In some illustrated embodiments the blade member is fabricated by cold forming a sheet metal ring to produce a desired configuration. The driver member is then molded in place on the blade member. The projecting blade end is then sharpened by a suitable process, such as grinding.

These and other features of the invention will become better understood by reference to the accompanying drawings.

### BRIEF DESCRIPTION OF THE DRAWINGS

FIG. 1 is a exploded perspective view of a rotary knife including a blade housing for supporting a rotary ring blade constructed according to the invention;

FIG. 2 is a cross-sectional view of the ring blade shown in FIG. 1 constructed according to the invention and mounted in and supported by a blade housing;

FIG. 3 is a perspective fragmentary view showing part of a ring blade constructed according to the invention;

FIG. 4 is a cross-sectional view of another alternative ring blade disposed in a mold, which is also shown in cross-section, during the ring blade fabrication;

FIG. 5 is a cross-sectional view of still another alternative ring blade constructed according to the invention mounted in and supported by a blade housing;

FIG. 6 is a cross-sectional view of the ring blade of FIG. 5 disposed in a mold, which is also shown in cross-section, during one stage of the ring blade fabrication; and,

FIG. 7 is a perspective fragmentary view showing part of the ring blade of FIG. 5.

### EXEMPLARY MODES FOR PRACTICING THE INVENTION

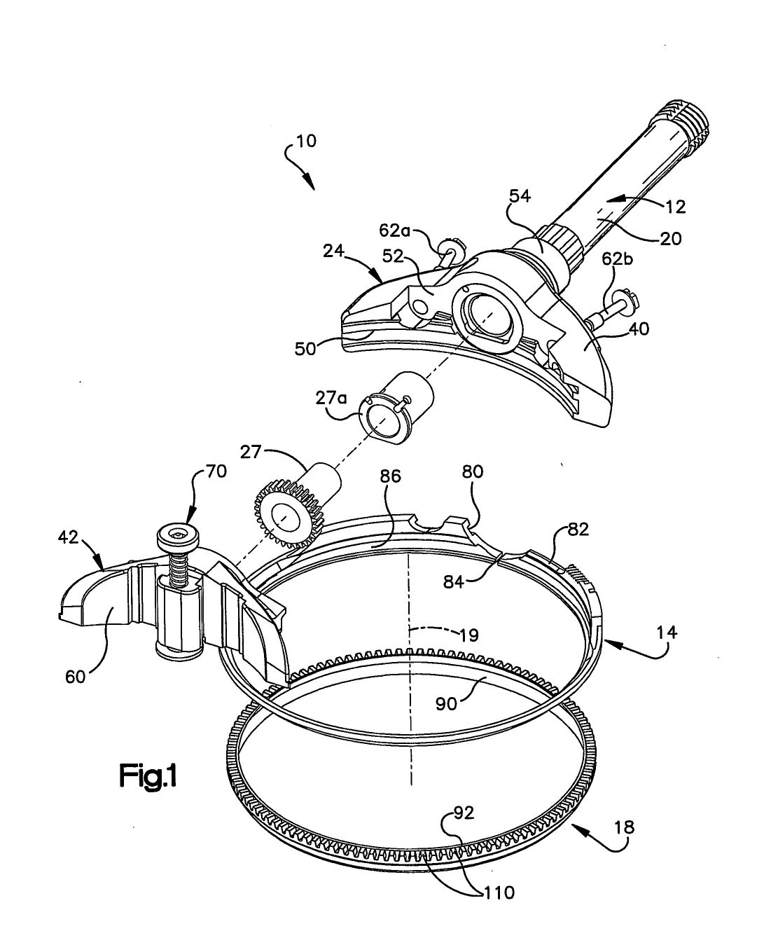

A rotary knife 10 embodying a ring blade constructed according to invention is illustrated in the drawings. As illustrated by FIG. 1, the rotary knife 10 comprises a handle assembly 12, a generally circular, split blade housing 14 supported by the handle assembly 12, and a ring blade 18 supported by the blade housing 14 for rotation about a central axis 19. The illustrated knife is connected to a remote electric motor by a flexible drive shaft (not shown) that extends into the knife handle assembly 12 to drive the ring blade via suitable gearing. The motor and drive shaft may be of any suitable or conventional construction and are not illustrated. It should be appreciated that other means may be employed to drive the blade 18. For example, an air motor may be mounted in the handle assembly 12 and connected to a source of pressurized air via a suitable hose, or an electric motor may be mounted in the handle assembly 12 and connected to a power source by a power cord.

The handle assembly 12 and blade housing 14 are constructed as disclosed in PCT application Ser. No. PCT/US00/27488, filed Oct. 5, 2000 the disclosure of which is incorporated herein in its entirety by this reference to it. Accordingly, the handle assembly and blade housing are described briefly here.

The illustrated handle assembly 12 extends away from the blade 18 and blade housing 14 along a line that is transverse to the axis 19 allowing a knife operator to wield the knife with one hand. The handle assembly 12 comprises a handle supporting tubular frame member 20, a head assembly 24 fixed to the frame member 20. A removable, ergonomic handle(not shown) surrounds frame member 20 and provides a gripping surface for an operator.

The frame member 20 is adapted to receive various ergonomic handles having different configurations to permit an operator to select a grip which is most comfortable for the operator's hand. The frame member 20 rigidly supports the head assembly 24 while providing a channel through which the flexible drive shaft extends to make a driving connection with the blade driving gearing.

The illustrated head assembly 24 comprises a head member 40, a clamp assembly 42 that detachably clamps the blade housing 14 and the blade 18 to the head member 40, a blade driving pinion gear 27 and a pinion gear supporting bearing 27a. The head assembly 24 also includes a conventional lubrication system (not shown) by which a relatively viscous lubricant may be supplied to the pinion gear 27, the blade 18 and the blade housing 14 via suitable passages.

The head member 40 positions the blade housing 14 relative to the handle assembly 12. The illustrated head member 40 is a generally crescent shaped body that defines a semicircular blade housing seating region 50, a clamp assembly receiving, socket-like cavity 52, and a boss 54 that surrounds the frame member 20 and projects from the head member body opposite to the cavity 52 and seating region 50. The pinion gear bearing 27a is a tubular member that is attached to the head member 40 and surrounds a shank of the pinion gear. The illustrated clamp assembly 42 includes a steeling mechanism 70 by which the blade 18 is straightened by a knife operator.

The clamp assembly 42 firmly maintains the blade housing 14 seated again the seating region 50 to rigidly position the blade 18 while covering the pinion gear 27 which might otherwise be directly exposed to meat, fat, bone chips, etc. The clamp assembly 42 comprises a clamp body 60 and clamping screws 62a, 62b.

The ring blade 18 is removed and replaced without the necessity of removing the blade housing 14 from the head member 40. The blade housing 14 has first and second end portions 80, 82 extending circumferentially away from opposite sides of the blade housing split 84 and defines a radially inwardly opening circumferential groove 86 that receives the blade 18. The blade housing 14 is split to enable its resilient expansion for removing and replacing the blade 18 when the clamp assembly 42 is loosened.

FIGS. 1-3 illustrate a ring blade 18 constructed according to the invention that comprises a first blade member 90 and a second member 92 fixed to the first member 90 for driving the first member rotatably about the central axis 19. The illustrated blade member 90 is formed by a continuous annulus having a wedge-shaped body section 94 extending about the central axis 19 and having a cutting edge 96 formed at one axial end for cutting into material with which the ring blade is brought into contact. The member 90 is formed by machining tubular stock material and appropriately hardening the material preparatory to grinding the axial blade end to form the cutting edge 96. The manner of forming the blade member 90 is generally the same as known in the art, i.e., it is machined from tubular, high carbon, hardenable stainless steel stock, except that operations related to hobbing gear teeth on the blade member at the axial end 98 opposite from the edge 96 are not performed. This results in a much simpler and less costly blade member.

As shown in the Figures, the member 90 comprises structure by which the members 90, 92 are fixed together. In the embodiment of the invention illustrated by FIGS. 1-3 the body section remote from the blade edge 96 is relatively thick and has a circumferential groove 102 formed in it that extends radially inwardly from the outer periphery and a radially extending portion 104 that is knurled to produce a series of radial ridges 106 extending about the blade. The illustrated radially extending portion 104 is formed by an annular axial end face of the blade member.

The driving member 92 defines at least a drive surface by which rotatable drive is imparted to the ring blade 18. In the ring blade illustrated by FIGS. 1-3, the member 92 is molded, and fixedly mounted, on the blade member. The driving member 92 is formed about the member 90 so that the material forming the driving member 92 extends into the groove 102 and conforms to the ridged radially extending portion 104. The conformation of the driving member with the ridges 106 locks the members 90, 92 against relative rotation about the central axis 19 while the material in the groove 102 prevents relative axial movement between the members 90, 92. In this way the members 90, 92 are positively, drivingly engaged. While a circumferential groove 102 and a coacting knurled end face 104 have been described as fixing the members 90, 92 together, other suitable structures may be employed.

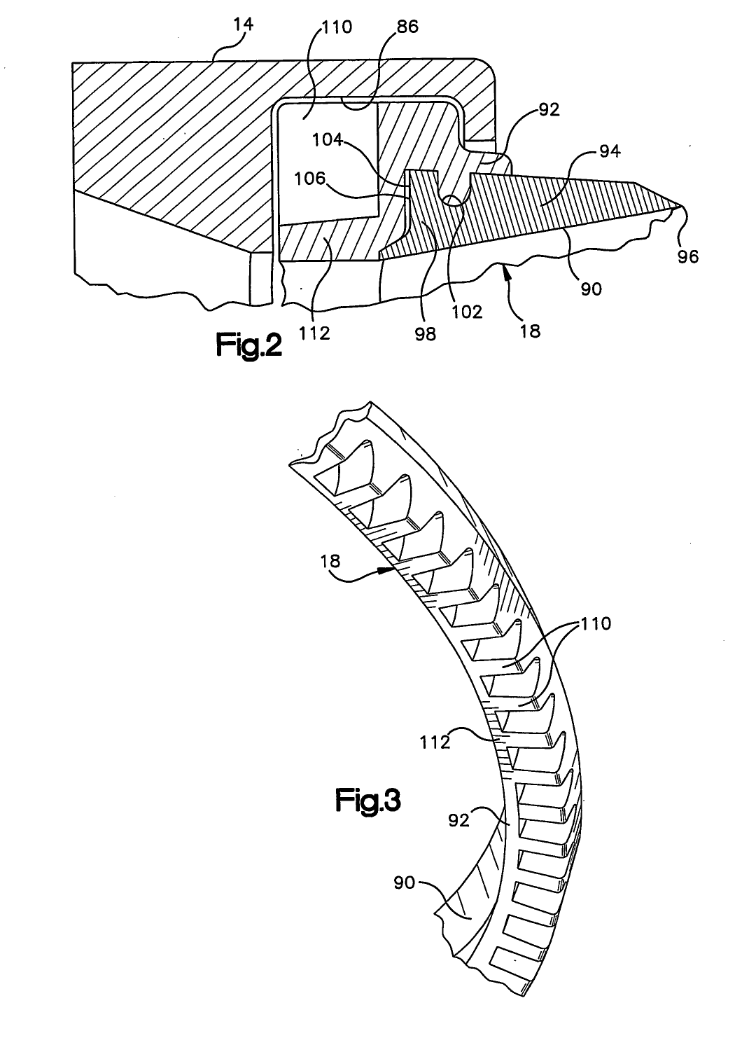

The driving member 92 is configured to slidingly fit within the blade housing 14 and the drive surface is illustrated as comprising gear teeth 110 that project axially from the blade member 90 in a direction opposite from the edge 96. These gear teeth mesh with the pinion gear for driving the blade 18. As best shown in FIGS. 2 and 3 the driving member 92 defines an axially extending cylindrical wall 112 along its inner periphery. The gear teeth 110 are continuous with and project radially outwardly from the wall 112. The wall 112 functions to strengthen and support the teeth.

Although the driving surface on the member 92 is illustrated as formed by gear teeth, it is to be understood that any suitable manner of transmitting drive to the blade 18 may be employed.

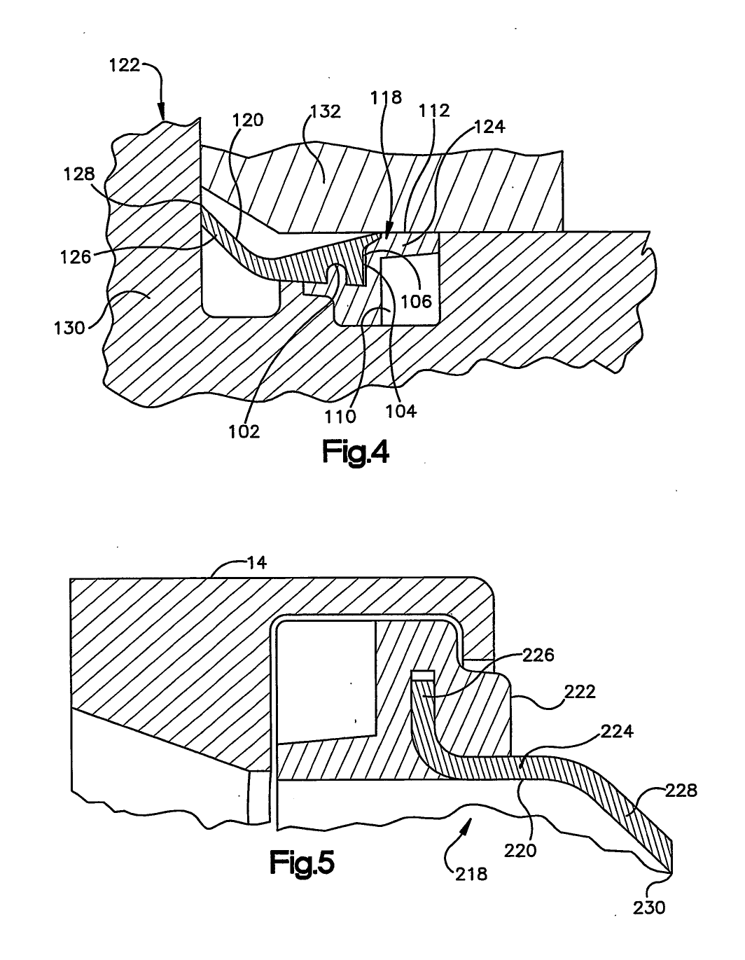

FIG. 4 illustrates a step in the fabrication process of a rotary blade 118 embodying the invention. As illustrated, a blade member 120 has been placed in the cavity of a mold 122 and material forming the driving member 124 has been injected into the mold cavity. The blade member 120 is constructed like the blade member 90 except that the blade body section 126 is machined so that it is relatively thin and forms a radially inwardly convergent frustoconical end portion leading to the cutting edge 128. The remaining structural features of the blade 118 are the same as those described above with respect to the blade 18 and are therefore designated by like reference characters.

As shown in the Figure, the blade 118 is disposed within a cavity formed by separable mold members 130, 132. The mold members 130,132 are constructed to form an annular closed cavity when the mold members are closed on the blade member 120. When the mold is closed, the material forming the blade driving member 124 is injected into the cavity where it conforms to the blade member and hardens so that the blade and driving members are secured together. When the driving member material has hardened the mold members 130, 132 are separated to release the blade 118. The illustrated mold member 130 is radially split so that after the mold member 132 has been removed, the split parts of the mold member 130 are separated to free the blade 118. The illustrated driving member is constructed like the driving member described above in reference to FIGS. 1-3 and therefore will not be described further here. Structural features of the blade driving member 124 are designated by the same reference characters as those applied to the blade driving member 92.

The driving member material in the illustrated embodiments is a highly engineered resin material such as polyphenyl sulfone, polyimide, or polyetheretherketone. Although resin materials are used for the driving member in the illustrated embodiments, other materials are also possible. For example, the driving member could be constructed by injection molding a resin loaded with powdered metal onto the blade member and then heat treating the molded structure to shrink the member to its final size while driving off the resin.

The blade 18 illustrated by FIGS. 1-3 is fabricated like the blade 118. It should be noted that the hardened blade member may be ground to produce the cutting edge after the driving member is molded in place if that is desirable.

FIGS. 5-7 illustrate another alternatively constructed blade 218 having a blade member 220 formed from a cold-formed sheet of metal and a driving member 222 that is molded in place on and fixed to the blade member. The illustrated blade member is formed by stamping a sheet of hardenable high carbon stainless steel to form an annulus, and deep drawing the annulus to produce a generally cylindrical blade body portion 224 projecting axially from a radially extending flange portion 226 and having a radially inwardly converging frusto-conical section 228 at its axial end opposite from the flange 226.

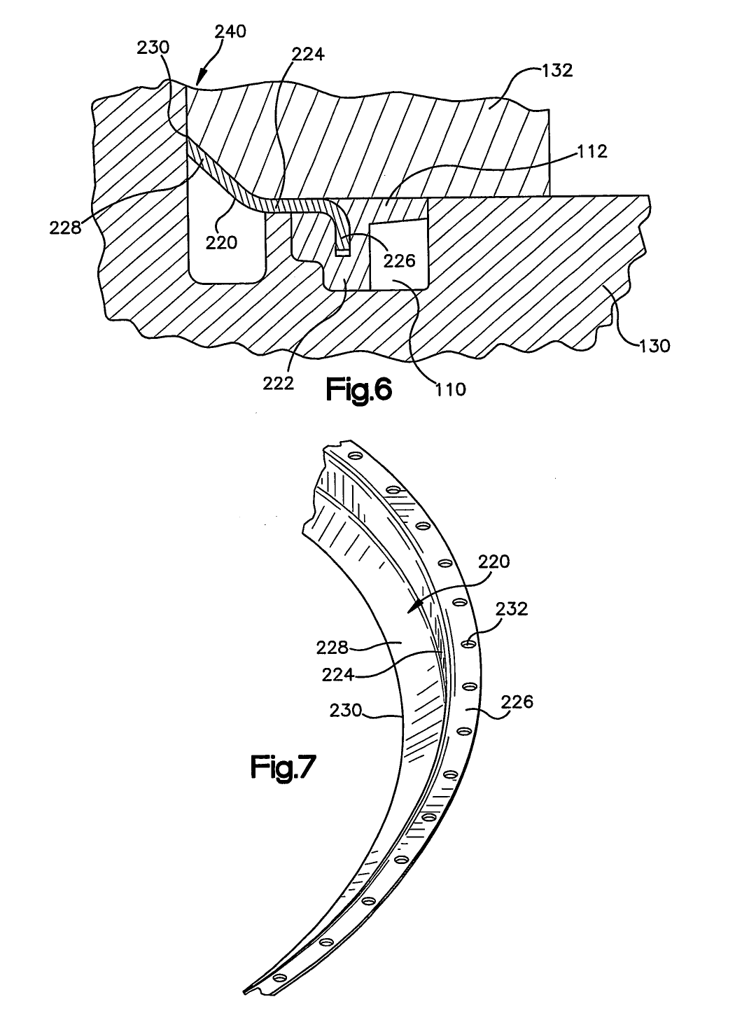

The blade member 220 comprises structure for fixing the members 220, 222 together. In the illustrated blade 218, the flange 226 defines an annular array of holes 232 for receiving the material of the member driving member 222 (See FIG. 7).

The illustrated blade member 220 is heat treated after being formed and then the axial end face of the section 228 is ground to produce an annular cutting edge 230 along its radially inner periphery.

Referring to FIG. 6, after the blade member 220 has been formed it is placed in a mold 240 and material forming the driving member is injected into the mold. The flange 226 is engulfed by the material of the member 222 and the driving member material fills the holes 232 to assure that the blade and driving members are fixed together.

The driving member 222 is configured substantially like the driving members described in reference to FIGS. 1-4 and is not described further. Likewise, the mold 240 may be constructed as described previously, or in any suitable manner, and therefore is not described further. Parts of the driving member 222 and mold 240 that correspond to parts described previously are indicated by identical reference characters in FIG. 6.

Although different embodiments of the invention have been illustrated and described in considerable detail, the invention is not to be considered limited to the precise constructions disclosed. Various adaptations, modifications and uses of the invention may occur to those skilled in the art to which the invention relates and it is the intention to cover hereby all such adaptations, modifications and used that fall within the scope or spirit of the appended claims.

1. A ring blade comprising
a first blade member formed by a continuous annulus extending about a central axis and having a cutting edge formed at one axial end for cutting into material with which said ring blade is brought into contact; and
a second member fixed to said first member for driving the first member rotatably about the central axis, said second member defining at least a drive surface by which rotatable drive is imparted to the ring blade.

2. The ring blade claimed in claim 1 wherein said first blade member is formed from a thin sheet of material having a frustoconical section extending between the second member and the cutting edge.

3. The ring blade claimed in claim 1 wherein said first blade member is formed from a thin sheet-like member.

4. The ring blade claimed in claim 1 wherein said second member is formed from molded material.

5. The ring blade claimed in claim 4 wherein said first member defines structure by which said first and second members are mechanically locked together.

6. The ring blade claimed in claim 4 wherein second member is molded in place on said first member.

7. The ring blade claimed in claim 3 wherein said first blade member is a continuous piece of sheet metal that is cold-formed into to the annular shape.

8. The ring blade claimed in claim 3 wherein said blade member defines a radially extending portion spaced from the cutting edge, said radially extending portion interlocked with said second member.

9. The ring blade claimed in claim 8 wherein said radially extending portion defines a plurality of openings into which parts of the second member extend for interlocking the members.

10. The ring blade claimed in claim 8 wherein said radially extending portion is defined by an annular axial end face having a plurality of ridges formed therein.

11. The ring blade claimed in claim 1 wherein said second member defines a series of gear teeth by which the ring blade is driven.

12. The ring blade claimed in claim 1 wherein said second member is formed from a plastic material.

13. The ring blade claimed in claim 1 wherein said second member is molded in place to said first member and said first member is formed from a continuous thin sheet metal ring.

14. A method of making a ring blade comprising:
a.) forming a continuous annular blade member having a central axis and opposite axial ends;
b) forming a cutting edge on one axial end of said blade member;
c) placing the blade member in a mold cavity;
d) forming a blade driving member by molding a body of material onto said blade member so that said body of material and said blade member are fixed with respect to each other.

15. The method claimed in claim 14 wherein forming said blade member comprises drawing an annular sheet of metal material to form a frustoconical section between said cutting edge and the opposite axial blade end.

16. The method claimed in claim 15 further comprising forming a radial flange on said blade member an a plurality of holes in said flange.
